(19) United States
(12) Patent Application Publication
(10) Pub. No.: US 2009/0267711 A1
(43) Pub. Date: Oct. 29, 2009

(54) High frequency circuit

(75) Inventor: Shigeru Kawabata, Kobe-shi (JP)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: Agilent Technologies, Inc., Santa Clara, CA (US)

(21) Appl. No.: 12/108,838

(22) Filed: Apr. 24, 2008

(51) Int. Cl. H01P 3/08; H01P 1/22

(52) U.S. Cl. 333/238; 333/81 A

(57) ABSTRACT

A circuit has a first coplanar line including a first strip conductor formed on the first plane of a dielectric substrate and a first grounded conductor formed on the first plane and disposed on one side of the first strip conductor, and a second coplanar line including a second strip conductor formed on a second plane of the dielectric substrate and a second grounded conductor formed on the second plane and disposed on one side of the second strip conductor, where the first strip conductor and the second strip conductor are electrically connected in parallel and are plane symmetric with respect to the dielectric substrate, and the first grounded conductor and the second grounded conductor are electrically connected in parallel and are plane symmetric with respect to the dielectric substrate.

The disclosed embodiments pertain to a high-frequency circuit, and relates to a circuit having coplanar lines.

### BACKGROUND

The line portion of a conventional RF circuit or microwave circuit is formed from a coplanar wave guide (CWG hereafter) or microstrip line (MSL hereafter). Refer to FIGS. 1a, 1b, and 2. FIGS. 1a and 1b are drawings showing an attenuator 100 that uses MSL technology. FIGS. 1a and 1b show the first prior art, and show the front and back surfaces of attenuator 100, respectively. FIG. 2 is the AA′ cross section of FIG. 1a. The same reference numerals are used for the same structural elements in FIGS. 1a, 1b, and 2.

An attenuator 100 in FIGS. 1a and 1b comprises a printed circuit board 101, and a shield case 102 for covering printed circuit board 101. The printed circuit board is referred to as a PCB hereafter. PCB 101 comprises a substrate 103, strip-shaped line conductors 104 and 105 formed on the front surface of substrate 103, a grounded conductor 106 formed over the entire back surface of substrate 103, chip resistors 107, 108, and 109 mounted on the front surface of substrate 103, and a via 110. One end of line conductor 104 is electrically connected to an inner conductor 112 of a coaxial cable 111. Moreover, the other end of line conductor 104 is electrically connected to an inner conductor 115 of a coaxial cable 114. Chip resistors 107 and 108 are inserted in line conductor 104 such that line conductor 104 is divided into three segments. One end of chip resistor 109 is electrically connected to line conductor 104 between chip resistor 107 and chip resistor 108, and the other end is electrically connected to line conductor 105. Line conductor 105 is electrically connected to grounded conductor 106 by via 110 that passes through substrate 103. Shield case 102 is electrically connected to an outer conductor 113 of coaxial cable 111, an outer conductor 116 of coaxial cable 114, and grounded conductor 106.

The second prior art is a microwave integrated circuit having lines formed from two symmetrically disposed CWGs as disclosed in JP (Kokai [Unexamined Patent Application]) 2005-217582. Such a microwave integrated circuit does not require metal walls enclosing the line conductors in transmission lines having low loss and a high Q value.

By means of attenuator 100 of the first prior art, the terminal portions of the chip parts have an unnecessary inductive component. Via 110 also has an unnecessary inductive component. An unnecessary capacitive component C is present between each line conductor and grounded conductor 106. The properties of these unnecessary inductive and capacitive components are predominately determined by the relative permittivity and thickness of the dielectric substrate and the shape and size of the electronic parts mounted on the dielectric substrate, and cannot be freely changed by design. Such unnecessary inductive and capacitive components eventually become factors in the degradation of the frequency properties of attenuator 100. Moreover, the microwave integrated circuit of the second prior art does not take into consideration the mounting of electronic parts on the substrate.

It would be advantageous to provide a circuit having coplanar lines with which parts can be easily positioned and designed.

### SUMMARY

By means of the disclosed embodiments, coplanar lines comprising a strip-shaped line conductor and a conductor disposed on one side of the strip-shaped line conductor are formed on the front and back surfaces of the dielectric substrate. These coplanar lines are electrically connected in parallel, and are plane symmetric with respect to the dielectric substrate. Moreover, at least a portion of the coplanar lines is covered or enclosed by a shielding member. The electronic parts inserted or connected to the coplanar lines are disposed on both the front and back surfaces of the dielectric substrate, and at least a portion of the circuit formed on the front and back surfaces is the identical or equivalent. It is preferred that these electronic parts be disposed so that they are plane symmetric with respect to the dielectric substrate with, for instance, an increase in frequency.

That is, the disclosed embodiments provide a circuit, characterized in having a first coplanar line comprising a first strip conductor formed on the first plane of a dielectric substrate and a first grounded conductor formed on the first plane and disposed on one side of the first strip conductor and a second coplanar line comprising a second strip conductor formed on a second plane of the dielectric substrate and a second grounded conductor formed on the second plane and disposed on one side of the second strip conductor, wherein the first strip conductor and the second strip conductor are electrically connected in parallel and are plane symmetric with respect to the dielectric substrate and the first grounded conductor and second grounded conductor are electrically connected in parallel and are plane symmetric with respect to the dielectric substrate.

In one example, at least a portion of the first coplanar line and at least a portion of the second coplanar line are covered or enclosed by a shielding member.

In another example, at least one first electronic part is inserted in the first strip conductor and at least one second electronic part, which is the identical or equivalent electronic part as the first electronic part, is inserted in the second strip conductor. The position of the second electronic part and the position of the first electronic part may be plane symmetric with respect to the dielectric substrate.

The circuit of yet another example also comprises at least one first electronic part having at least one end electrically connected to the first strip conductor and disposed on the other side of the first strip conductor. The circuit may also comprise at least one second electronic part, which is the identical or equivalent electronic part as the first electronic part, has at least one end electrically connected to the second strip conductor, and is disposed on the other side of the second strip conductor. Moreover, the position of the second electronic part and the position of the first electronic part may be plane symmetric with respect to the dielectric substrate.

In still another example, the circuit also comprises a third grounded conductor formed on the first plane and disposed on the other side of the first strip conductor, with the distance between the third grounded conductor and the first strip conductor being wider than the distance between the first grounded conductor and first strip conductor. The circuit may also comprise a fourth grounded conductor formed on the second plane and disposed on the other side of the second strip conductor, and the distance between the fourth grounded conductor and the second strip conductor may be wider than the distance between the second grounded conductor and the second strip conductor. The distance between the third grounded conductor and the first strip conductor may be greater by five times or more than the distance between the first grounded conductor and the first strip conductor.

Moreover, the distance between the fourth grounded conductor and the second strip conductor may be wider than the distance between the second grounded conductor and the second strip conductor. The distance between the fourth grounded conductor and the second strip conductor may be greater by five times or more than the distance between the second grounded conductor and the second strip conductor.

The disclosed embodiments also provide a circuit, characterized in having a first coplanar line comprising a first strip conductor formed on a first plane of a dielectric substrate and a second strip conductor formed on the first plane and disposed on one side of the first strip conductor and a second coplanar line comprising a third strip conductor and a fourth strip conductor formed on a second plane of the dielectric substrate, wherein the first strip conductor and the third strip conductor are electrically connected in parallel and are plane symmetric with respect to the dielectric substrate and the second strip conductor and the fourth strip conductor are electrically connected in parallel and are plane symmetric with respect to the dielectric substrate.

In one example, at least a portion of the first coplanar line and at least a portion of the second coplanar line are covered or enclosed by a shielding member.

In another example, the first strip conductor and the second strip conductor are disposed between the first grounded conductor formed on the first plane and the second grounded conductor formed on the first plane, the third strip conductor and the fourth strip conductor are disposed between the third grounded conductor formed on the second plane and the fourth grounded conductor formed on the second plane, the distance between the first strip conductor and the first grounded conductor and the distance between the second strip conductor and the second grounded conductor are less than half the distance between the first strip conductor and the second strip conductor; and the distance between the third strip conductor and the third grounded conductor and the distance between the fourth strip conductor and the fourth grounded conductor are less than half the distance between the third strip conductor and the fourth strip conductor. The distance between the first strip conductor and the first grounded conductor and the distance between the second strip conductor and the second grounded conductor may be 1/10 or less the distance between the first strip conductor and second strip conductor. The distance between the third strip conductor and the third grounded conductor and the distance between the fourth strip conductor and the fourth grounded conductor may be 1/10 or less the distance between the third strip conductor and the fourth strip conductor.

In yet another example, the first strip conductor and the second strip conductor are disposed between the first grounded conductor formed on the first plane and the second grounded conductor formed on the first plane, the third strip conductor and the fourth strip conductor are disposed between the third grounded conductor formed on the second plane and the fourth grounded conductor formed on the second plane, the distance between the first strip conductor and the first grounded conductor and the distance between the second strip conductor and the second grounded conductor are greater than half the distance between the first strip conductor and the second strip conductor; and the distance between the third strip conductor and the third grounded conductor and the distance between the fourth strip conductor and the fourth grounded conductor are greater than half the distance between the third strip conductor and the fourth strip conductor. The distance between the first strip conductor and the first grounded conductor and the distance between the second strip conductor and the second grounded conductor may be greater by 2.5 times or more than the distance between the first strip conductor and the second strip conductor. Moreover, the distance between the third strip conductor and the third grounded conductor and the distance between the fourth strip conductor and the fourth grounded conductor may be greater by 2.5 times or more than the distance between the third strip conductor and the fourth strip conductor.

The dielectric substrate is a resin substrate. Examples of the resin substrate are a Teflon substrate, a Rogers substrate (RO series), a BT resin substrate, a glass epoxy substrate, and the like.

In the disclosed embodiments, two-conductor coplanar lines are connected in parallel and disposed plane symmetrically; therefore, the characteristic impedance of the coplanar lines is easily determined or controlled by adjusting the distance between the grounded conductor and the line conductor along one side of the line conductor within the same plane as the strip-shaped line conductor. Differential coplanar lines are connected in parallel and disposed plane symmetrically; therefore, the characteristic impedance of the coplanar lines is easily determined or controlled by adjusting the difference between strip-shaped line conductors within the same plane. As a result, the electronic parts are easily connected to the strip conductors of the coplanar lines. Moreover, in the disclosed embodiments, two or more coplanar lines are connected in parallel; therefore, there is an increase in the capacitive component per unit length of the coplanar lines and a reduction in the characteristic impedance of the coplanar lines. This characteristic is preferred when a plane waveguide such as a coplanar line or slot line is formed using a substrate having a low relative permittivity, such as a resin substrate. Furthermore, in the disclosed embodiments, two or more circuits are disposed such that they are plane symmetric with one another; therefore, the number of vias can be reduced and the unnecessary inductive component can be reduced when compared to conventional circuits. Moreover, in the disclosed embodiments, two or more circuits are connected in parallel and are disposed such that they are plane symmetric with one another; therefore, it is possible to reduce the influence of the unnecessary inductive component and the capacitive component on the circuit properties when compared to conventional circuits. Moreover, in the disclosed embodiments, two or more circuits are connected in parallel; therefore, the withstand power of the circuits can be increased when compared to a conventional circuit. In the disclosed embodiments, a high frequency circuit that previously could only have been produced with thin film circuit substrates and thick film circuit substrates such as used with integrated circuits can now be produced with discrete electronic parts, such as printed circuit boards and SMDs. As a result, by means of the disclosed embodiments, it is possible to have both a lower frequency circuit and higher frequency circuit present on the same substrate. Moreover, it is possible to provide the desired circuit using inexpensive materials and inexpensive manufacturing technology.

### BRIEF DESCRIPTION OF THE DRAWINGS

FIGS. 1a and 1b are drawings showing attenuator 100, which is the first prior art.

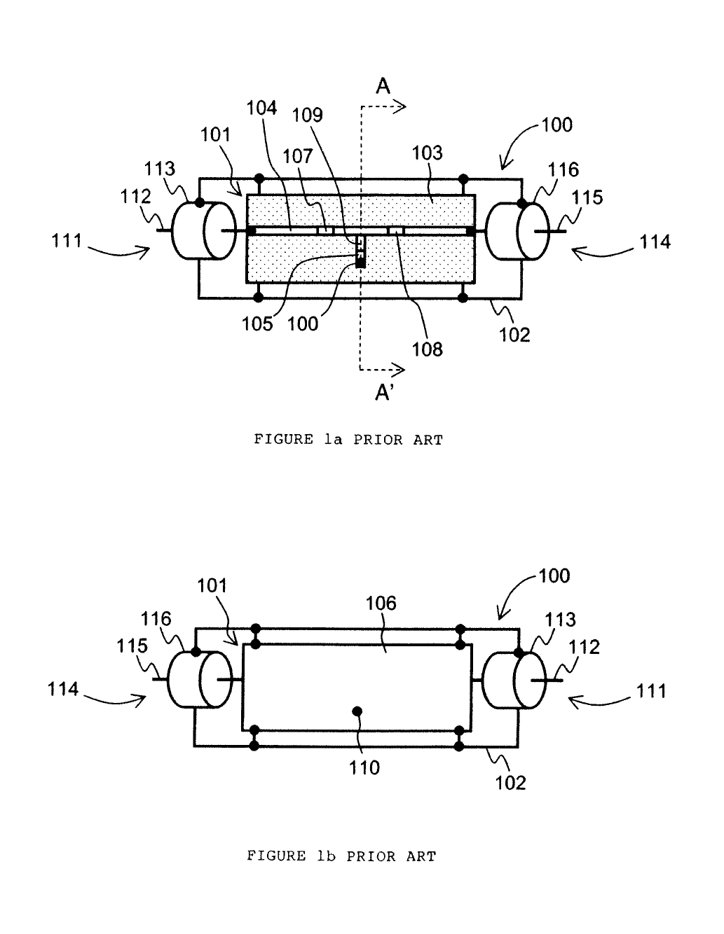

FIG. 2 is the AA′ cross section of FIG. 1a.

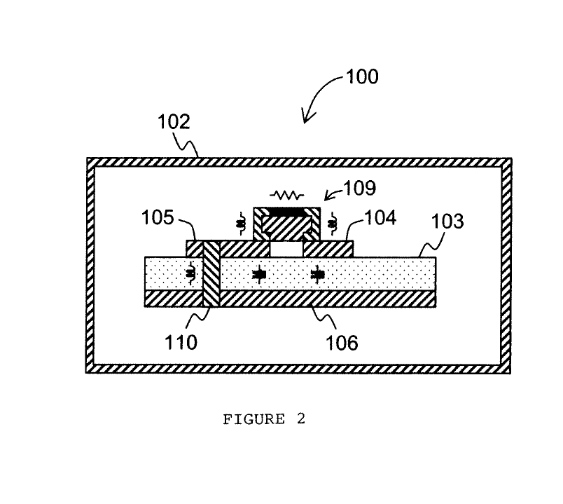

FIGS. 3a and 3b are drawings showing attenuator 200, according to a first embodiment.

FIG. 4 is the BB′ cross section of FIG. 3a.

FIGS. 5a and 5b are drawings showing power divider 300, according to a second embodiment.

FIGS. 6a and 6b are drawings showing power divider 400, according to a third embodiment.

FIGS. 7a and 7b are drawings showing attenuator 500, according to a fourth embodiment.

FIGS. 8a and 8b are drawings showing attenuator 600, according to a fifth embodiment.

### DETAILED DESCRIPTION

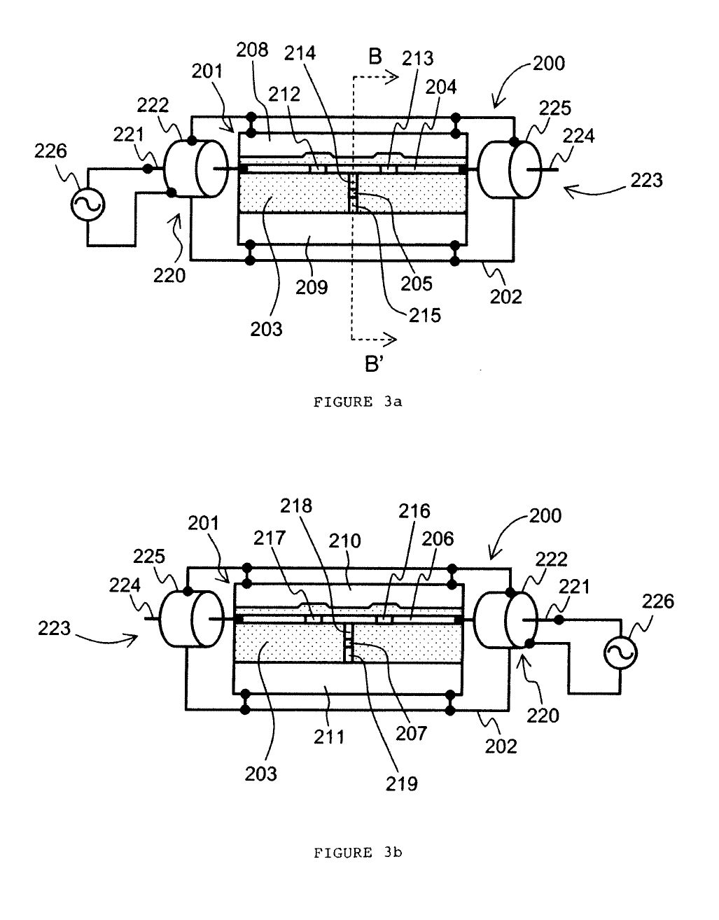

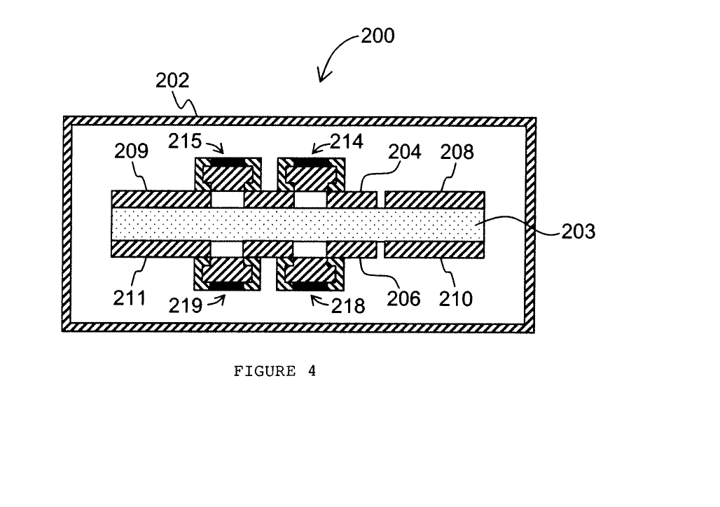

The embodiments will now be described in accordance with the attached drawings. The first embodiment is shown as an attenuator 200. Refer to FIGS. 3a, 3b, and 4. FIGS. 3a and 3b show the front surface and back surface of attenuator 200, respectively. FIG. 4 is the BB′ cross section in FIG. 3a. The same reference numerals are used for the same structural parts in FIGS. 3a, 3b, and 4.

Attenuator 200 in FIGS. 3a and 3b comprises a resin PCB 201 and a shield case 202 for covering PCB 201. PCB 201 comprises a substrate 203, strip-shaped line conductors 204 and 205 formed on the front surface of substrate 203, strip-shaped line conductors 206 and 207 formed on the back surface of substrate 203, grounded conductors 208 and 209 formed on the front surface of substrate 203, grounded conductors 210 and 211 formed on the back surface of substrate 203, chip resistors 212, 213, 214, and 215 mounted on the front surface of substrate 203, and chip resistors 216, 217, 218, and 219 mounted on the back surface of substrate 203. Grounded conductor 208 is disposed along line conductor 204. Line conductor 204 and grounded conductor 208 form at least two conductor type coplanar line. Grounded conductor 210 is disposed along line conductor 206. Line conductor 206 and grounded conductor 210 form at least two conductor type coplanar line. One end of line conductor 204 is electrically connected to an inner conductor 221 of a coaxial cable 220. The other end of line conductor 204 is electrically connected to an inner conductor 224 of a coaxial cable 223. One end of line conductor 206 is electrically connected to inner conductor 221. The other end of line conductor 206 is electrically connected to inner conductor 224.

Chip resistors 212 and 213 are inserted in line conductor 204 such that line conductor 204 is divided into three segments. Chip resistors 216 and 217 are inserted in line conductor 206 such that line conductor 206 is divided into three segments. One end of chip resistor 214 is electrically connected to line conductor 204 between chip resistor 212 and chip resistor 213, while the other end is electrically connected to line conductor 205. One end of chip resistor 215 is electrically connected to line conductor 205, while the other end is electrically connected to grounded conductor 209. One end of chip resistor 218 is electrically connected to line conductor 206 between chip resistor 216 and chip resistor 217, while the other end is electrically connected to line conductor 207. One end of chip resistor 219 is electrically connected to line conductor 207, while the other end is electrically connected to grounded conductor 211. Chip resistor 212 and chip resistor 216 are identical or equivalent. Chip resistor 213 and chip resistor 217 are identical or equivalent. Chip resistor 214 and chip resistor 218 are identical or equivalent. Chip resistor 215 and chip resistor 219 are identical or equivalent. Shield case 202 is electrically connected to an outer conductor 222 of coaxial cable 220, an outer conductor 225 of coaxial cable 223, grounded conductor 208, grounded conductor 209, grounded conductor 210, and grounded conductor 211.

Coaxial cable 220 is connected to a signal source 226. Line conductors 204 and 206 are driven under the same phase by signal source 226 via coaxial cable 220.

The distance between line conductor 204 and grounded conductor 208 is narrower than the distance between line conductor 204 and grounded conductor 209 at each place along line conductor 204. As a result, the characteristic impedance of the coplanar line containing line conductor 204 is determined or controlled based on the distance between line conductor 204 and grounded conductor 208. At each place on line conductor 206 the distance between line conductor 206 and grounded conductor 210 is narrower than the distance between line conductor 206 and grounded conductor 211. As a result, the characteristic impedance of the coplanar line containing line conductor 206 is determined or controlled by the distance between line conductor 206 and grounded conductor 210.

The circuit formed on the front surface of PCB 201 and the circuit formed on the back surface of PCB 201 are plane symmetric with respect to PCB 201. The phrase “plane symmetric with respect to the PCB” here means “plane symmetric with regard to an imaginary plane in the middle between the front and back surfaces of the PCB”. Consequently, the conductors formed on the front surface of PCB 201 and the corresponding conductors that are formed on the back surface of PCB 201 are plane symmetric with respect to PCB 201. Moreover, the position of the electronic parts mounted on the front surface of PCB 201 and the position of the corresponding electronic parts mounted on the back surface of PCB 201 are plane symmetric with respect to PCB 201. For instance, line conductor 204 and line conductor 206 are plane symmetric with respect to PCB 201. The position of resistor 212 and the position of resistor 216 are plane symmetric with respect to PCB 201. The position of resistor 214 and the position of resistor 218 are plane symmetric with respect to PCB 201.

It should be noted that the distance between line conductor 204 and grounded conductor 209 in this first embodiment is greater by five times or more than the distance between line conductor 204 and grounded conductor 208. In this case, the sensitivity of the distance between line conductor 204 and grounded conductor 209 to the characteristic impedance of the coplanar line that includes line conductor 204 becomes 1/10 or less the sensitivity of the distance between line conductor 204 and grounded conductor 208 to the characteristic impedance. As a result, grounded conductor 209 can be practically disregarded with respect to the characteristic impedance of the coplanar line containing line conductor 204. Preferably the distance between line conductor 206 and grounded conductor 211 is greater by five times or more than the distance between line conductor 206 and grounded conductor 210. In this case, the sensitivity of the distance between line conductor 206 and grounded conductor 211 to the characteristic impedance of the coplanar line containing line conductor 206 becomes 1/10 or less the sensitivity of the distance between line conductor 206 and grounded conductor 210 to the characteristic impedance. As a result, grounded conductor 211 can be practically disregarded with respect to the characteristic impedance of the coplanar line containing line conductor 206.

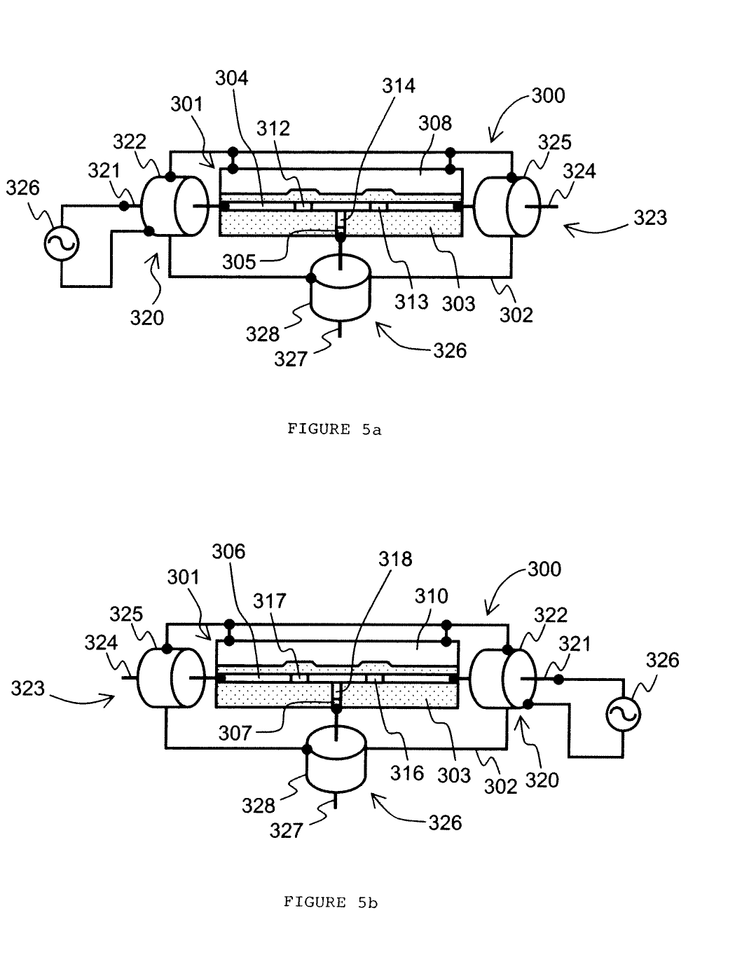

Next, the second embodiment will be described. The second embodiment is shown as a power divider 300. Refer to FIGS. 5a and 5b. FIGS. 5a and 5b show the front surface and the back surface of divider 300, respectively. The same reference numerals are used for the same structural elements in FIGS. 5a and 5b.

Divider 300 in FIGS. 5a and 5b comprises a resin PCB 301 and a shield case 302 covering PCB 301. PCB 301 comprises a substrate 303, strip-shaped line conductors 304 and 305 formed on the front surface of substrate 303, strip-shaped line conductors 306 and 307 formed on the back surface of substrate 303, a grounded conductor 308 formed on the front surface of substrate 303, a grounded conductor 310 formed on the back surface of substrate 303, chip resistors 312, 313, and 314 mounted on the front surface of substrate 303, and chip resistors 316, 317, and 318 mounted on the back surface of substrate 303. Grounded conductor 308 is disposed along line conductor 304. Line conductor 304 and grounded conductor 308 form at least two conductor type coplanar line. The characteristic impedance of the coplanar line containing line conductor 304 is determined or controlled by the distance between line conductor 304 and grounded conductor 308. Grounded conductor 310 is disposed along line conductor 306. Line conductor 306 and grounded conductor 310 form at least two conductor type coplanar line. The impedance of the coplanar line that contains line conductor 306 is determined or controlled by the distance between line conductor 306 and grounded conductor 310. One end of line conductor 304 is electrically connected to an inner conductor 321 of a coaxial cable 320. Moreover, the other end of line conductor 304 is electrically connected to an inner conductor 324 of a coaxial cable 323. One end of line conductor 306 is electrically connected to inner conductor 321. The other end of line conductor 306 is electrically connected to inner conductor 324.

Chip resistors 312 and 313 are inserted in line conductor 304 such that line conductor 304 is divided into three segments. Chip resistors 316 and 317 are inserted in line conductor 306 such that line conductor 306 is divided into three segments. One end of chip resistor 314 is electrically connected to line conductor 304 between chip resistor 312 and chip resistor 313, while the other end is electrically connected to line conductor 305. Line conductor 305 is electrically connected to an inner conductor 327 of coaxial cable 326. One end of chip resistor 318 is electrically connected to line conductor 306 between chip resistor 316 and chip resistor 317, while the other end is electrically connected to line conductor 307. Line conductor 307 is electrically connected to inner conductor 327 of coaxial cable 326. Chip resistor 312 and chip resistor 316 are identical or equivalent. Chip resistor 313 and chip resistor 317 are identical or equivalent. Chip resistor 314 and chip resistor 318 are identical or equivalent. Shield case 302 is electrically connected to an outer conductor 322 of coaxial cable 320, an outer conductor 325 of coaxial cable 323, an outer conductor 328 of coaxial cable 326, grounded conductor 308, and grounded conductor 309.

Coaxial cable 320 is connected to a signal source 329. Line conductors 304 and 306 are driven under the same phase by signal source 329 via coaxial cable 320.

The circuit formed on the front surface of PCB 301 and the circuit formed on the back surface of PCB 301 are plane symmetric with respect to PCB 301. Consequently, the conductors formed on the front surface of PCB 301 and the corresponding conductors formed on the back surface of PCB 301 are plane symmetric with respect to PCB 301. Moreover, the position of the electronic parts mounted on the front surface of PCB 301 and the positions of the corresponding chip resistors mounted on the back surface of PCB 301 are plane symmetric with respect to PCB 301. For instance, line conductor 304 and line conductor 306 are plane symmetric with respect to PCB 301. The position of resistor 312 and the position of resistor 316 are plane symmetric with respect to PCB 301. The position of resistor 314 and the position of resistor 318 are plane symmetric with respect to PCB 301.

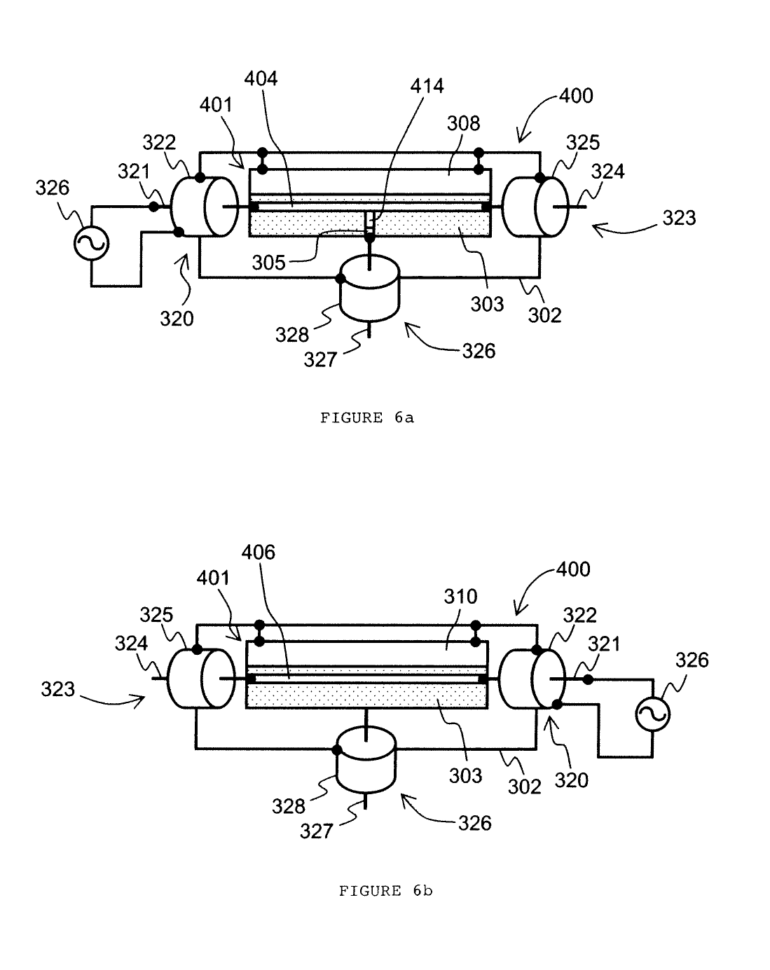

The third embodiment will now be described. The third embodiment is shown as a power divider 400. Divider 400 is a modification of divider 300. Refer to FIGS. 6a and 6b. FIGS. 6a and 6b show the front and back surfaces of divider 400, respectively. The same reference numerals are used in FIGS. 6a and 6b for the structural elements that are the same as the elements in FIGS. 5a and 5b.

Divider 400 has a strip-shaped line conductor 404 formed on the front surface of substrate 303 and a strip-shaped line conductor 406 formed on the back surface of substrate 303 in place of line conductor 304 and line conductor 306. Moreover, divider 400 has a chip resistor 414 mounted on the front surface of substrate 303 in place of resistors 312, 313, 314, 316, 317, and 318. Consequently, in FIGS. 6a and 6b, divider 400 comprises a resin PCB 401 and shield case 302 for covering PCB 401. Moreover, PCB 401 comprises substrate 303, strip-shaped line conductors 404 and 305 formed on the front surface of substrate 303, strip-shaped line conductor 406 formed on the back surface of substrate 303, grounded conductor 308 formed on the front surface of substrate 303, grounded conductor 310 formed on the back surface of substrate 303, and chip resistor 414 mounted on the front surface of substrate 303. One end of line conductor 404 is electrically connected to inner conductor 321. Moreover, the other end of line conductor 404 is electrically connected to inner conductor 324. One end of line conductor 406 is electrically connected to inner conductor 321. The other end of line conductor 406 is electrically connected to inner conductor 324. One end of chip resistor 414 is electrically connected to line conductor 404, and the other end is electrically connected to line conductor 305. Inner conductor 327 is connected to line conductor 305.

Grounded conductor 308 is disposed along line conductor 404. Line conductor 404 and grounded conductor 308 form at least two conductor type coplanar line. The characteristic impedance of the coplanar line containing line conductor 404 is determined or controlled by the distance between line conductor 404 and grounded conductor 308. Grounded conductor 310 is disposed along line conductor 406. Line conductor 406 and grounded conductor 310 form at least two conductor type coplanar line. The characteristic impedance of the coplanar line containing line conductor 406 is determined or controlled by the distance between line conductor 406 and grounded conductor 310. Conductors 308 and 404 formed on the front surface of PCB 301 and the identical or equivalent conductors 310 and 406 formed on the back surface of PCB 301 are plane symmetric with regard to PCB 301.

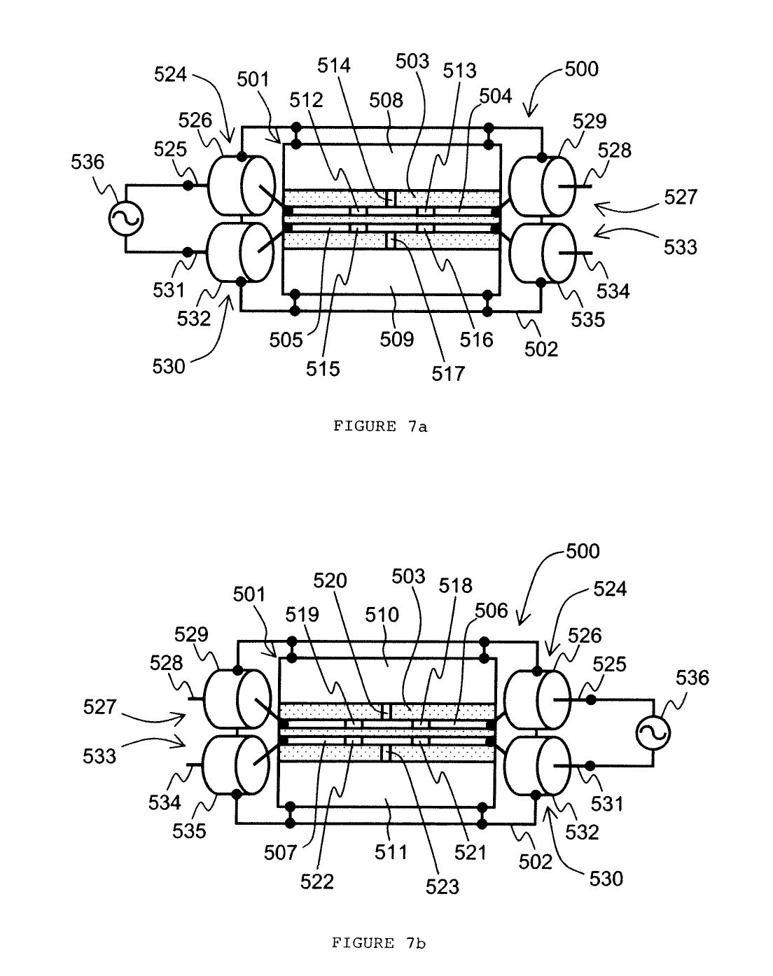

A fourth embodiment will now be described. The fourth embodiment is shown as an attenuator 500 for differential signals. Refer to FIGS. 7a and 7b. FIGS. 7a and 7b show the front surface and the back surface of attenuator 500, respectively. The same reference numerals are used for the same structural elements in FIGS. 7a and 7b.

Attenuator 500 in FIGS. 7a and 7b comprises a resin PCB 501 and a shield case 502 for covering PCB 501. PCB 501 comprises a substrate 503, strip-shaped line conductors 504 and 505 formed on the front surface of substrate 503, strip-shaped line conductors 506 and 507 formed on the back surface of substrate 503, grounded conductors 508 and 509 formed on the front surface of substrate 503, grounded conductors 510 and 511 formed on the back surface of substrate 503, chip resistors 512, 513, 514, 515, 516, and 517 mounted on the front surface of substrate 503, and chip resistors 518, 519, 520, 521, 522, and 523 mounted on the back surface of substrate 503. One end of line conductor 504 is electrically connected to an inner conductor 525 of a coaxial cable 524. Moreover, the other end of line conductor 504 is electrically connected to an inner conductor 528 of a coaxial cable 527. One end of line conductor 505 is electrically connected to an inner conductor 531 of a coaxial cable 530. The other end of line conductor 505 is electrically connected to an inner conductor 534 of a coaxial cable 533. One end of line conductor 506 is electrically connected to inner conductor 525. The other end of line conductor 506 is electrically connected to inner conductor 528. One end of line conductor 507 is electrically connected to inner conductor 531. The other end of line conductor 507 is electrically connected to inner conductor 534.

Chip resistors 512 and 513 are inserted in line conductor 504 such that line conductor 504 is divided into three segments. One end of chip resistor 514 is electrically connected to line conductor 504 between chip resistor 512 and chip resistor 513, and the other end is electrically connected to grounded conductor 508. Chip resistors 515 and 516 are inserted in line conductor 505 such that line conductor 505 is divided into three segments. One end of chip resistor 517 is electrically connected to line conductor 505 between chip resistor 515 and chip resistor 516, while the other end is electrically connected to grounded conductor 509. Chip resistors 518 and 519 are inserted in line conductor 506 such that line conductor 506 is divided into three segments. One end of chip resistor 520 is electrically connected to line conductor 506 between chip resistor 518 and chip resistor 519, and the other end is electrically connected to grounded conductor 510. Chip resistors 521 and 522 are inserted in line conductor 507 such that line conductor 507 is divided into three segments. One end of chip resistor 523 is electrically connected to line conductor 507 between chip resistor 521 and chip resistor 522, and the other end is electrically connected to grounded conductor 511. Chip resistor 512 and chip resistor 518 are identical or equivalent. Chip resistor 513 and chip resistor 519 are identical or equivalent. Chip resistor 514 and chip resistor 520 are identical or equivalent. Chip resistor 515 and chip resistor 521 are identical or equivalent. Chip resistor 516 and chip resistor 522 are identical or equivalent. Chip resistor 517 and chip resistor 523 are identical or equivalent. Shield case 502 is electrically connected to an outer conductor 526 of coaxial cable 524, an outer conductor 529 of coaxial cable 527, an outer conductor 532 of coaxial cable 530, an outer conductor 535 of coaxial cable 533, grounded conductor 508, grounded conductor 509, grounded conductor 510, and grounded conductor 511.

The distance between line conductor 504 and grounded conductor 508 everywhere on line conductor 504 is wider than half the distance between line conductor 504 and line conductor 505. The distance between line conductor 505 and grounded conductor 509 everywhere on line conductor 505 is wider than half the distance between line conductor 504 and line conductor 505. The distance between line conductor 506 and grounded conductor 510 everywhere on line conductor 506 is wider than half the distance between line conductor 506 and line conductor 507. The distance between line conductor 507 and grounded conductor 511 everywhere on line conductor 507 is wider than half the distance between line conductor 506 and line conductor 507. Coaxial cables 524 and 530 are connected to a signal source 536. Line conductors 504 and 506 are driven under the same phase by signal source 536 via coaxial cable 524. Moreover, line conductors 505 and 507 are driven under the same phase by signal source 536 via coaxial cable 530. It should be noted that line conductor 505 is driven under the phase opposite that of line conductor 504. As a result, the characteristic impedance of the differential coplanar line containing line conductors 504 and 505 is determined or controlled by the distance between line conductor 504 and line conductor 505. Moreover, the characteristic impedance of the differential coplanar line containing line conductors 506 and 507 is determined or controlled by the distance between line conductor 506 and line conductor 507.

The circuit formed on the front surface of PCB 501 and the circuit formed on the back surface of PCB 501 are plane symmetric with respect to PCB 501. Consequently, the conductors formed on the front surface of PCB 501 and the corresponding conductors formed on the back surface of PCB 501 are plane symmetric with respect to PCB 501. Moreover, the position of the chip resistors mounted on the front surface of PCB 501 and the position of the corresponding chip resistors mounted on the back surface of PCB 501 are plane symmetric with respect to PCB 501. For instance, line conductor 504 and line conductor 506 are plane symmetric with respect to PCB 501. The position of resistor 512 and the position of resistor 518 are plane symmetric with respect to PCB 501. The position of resistor 514 and the position of resistor 520 are plane symmetric with respect to PCB 501.

It should be noted that it is preferred that the distance between line conductor 504 and grounded conductor 508 be greater by 2.5 times or more than the distance between line conductor 504 and line conductor 505 in the present embodiment. In this case, the sensitivity of the distance between line conductor 504 and ground conductor 508 to the characteristic impedance of the coplanar line including line conductor 504 becomes 1/10 or less the sensitivity of the distance between line conductor 504 and line conductor 505 to the same characteristic impedance. As a result, grounded conductor 508 can be practically disregarded with respect to the characteristic impedance of the coplanar line containing line conductor 504. Moreover, the distance between line conductor 505 and grounded conductor 509 is preferably greater by 2.5 times or more than the distance between line conductor 504 and line conductor 505. In this case, the sensitivity of the distance between line conductor 505 and grounded conductor 509 to the characteristic impedance of the coplanar line containing line conductor 505 becomes 1/10 or less the sensitivity to the distance between line conductor 504 and line conductor 505 to the same characteristic impedance. As a result, grounded conductor 509 can be practically disregarded with respect to the characteristic impedance of the coplanar line containing line conductor 504. The distance between line conductor 506 and grounded conductor 510 is preferably greater by 2.5 times or more than the distance between line conductor 506 and line conductor 507. In this case, the sensitivity of the distance between line conductor 506 and grounded conductor 510 to the characteristic impedance of the coplanar line containing line conductor 506 becomes 1/10 or less the sensitivity to the distance between line conductor 506 and line conductor 507 to the same characteristic impedance. As a result, grounded conductor 510 can be practically disregarded with respect to the characteristic impedance of the coplanar line containing line conductor 506. The distance between line conductor 507 and grounded conductor 511 is preferably greater by 2.5 times or more than the distance between line conductor 506 and line conductor 507. In this case, the sensitivity of the distance between line conductor 507 and grounded conductor 511 to the characteristic impedance of the coplanar line containing line conductor 507 becomes 1/10 or less the sensitivity to the distance between line conductor 506 and line conductor 507 to the same characteristic impedance. As a result, grounded conductor 511 can be practically disregarded with respect to the characteristic impedance of the coplanar line containing line conductor 507.

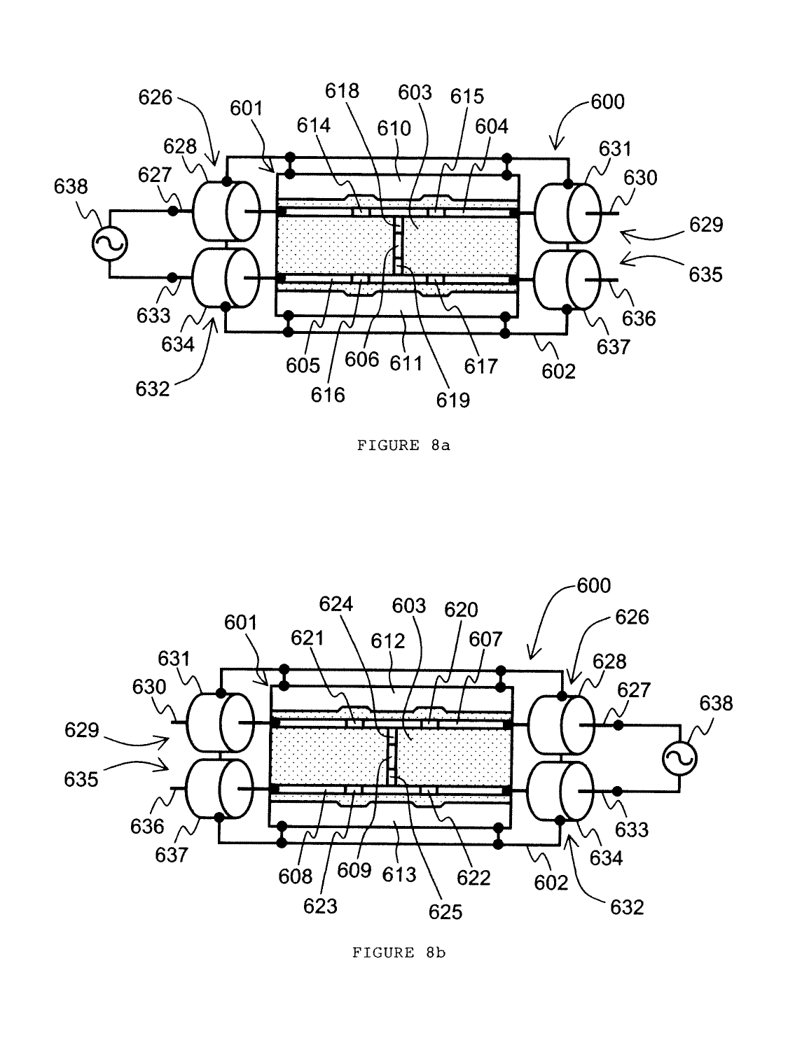

The fifth embodiment will now be described. The fifth embodiment is shown as an attenuator 600 for differential signals. Refer to FIGS. 8a and 8b. FIGS. 8a and 8b show the front surface and the back surface of attenuator 600, respectively. The same reference numerals are used for the same structural elements in FIGS. 8a and 8b.

Attenuator 600 in FIGS. 8a and 8b comprises a resin PCB 601 and a shield case 602 for covering PCB 601. PCB 601 comprises a substrate 603, strip-shaped line conductors 604, 605, and 606 formed on the front surface of substrate 603, strip-shaped line conductors 607, 608, and 609 formed on the back surface of substrate 603, grounded conductors 610 and 611 formed on the front surface of substrate 603, grounded conductors 612 and 613 formed on the back surface of substrate 603, chip resistors 614, 615, 616, 617, 618, and 619 mounted on the front surface of substrate 603, and chip resistors 620, 621, 622, 623, 624, and 625 mounted on the back surface of substrate 603. Grounded conductor 610 is disposed along line conductor 604. Line conductor 604 and grounded conductor 610 form at least two conductor type coplanar line. Grounded conductor 611 is disposed along line conductor 605. Line conductor 605 and grounded conductor 611 form at least two conductor type coplanar line. Grounded conductor 612 is disposed along line conductor 607. Line conductor 607 and grounded conductor 612 form at least two conductor type coplanar line. Grounded conductor 613 is disposed along line conductor 608. Line conductor 608 and grounded conductor 613 form at least two conductor type coplanar line. One end of line conductor 604 is electrically connected to an inner conductor 627 of a coaxial cable 626. Moreover, the other end of line conductor 604 is electrically connected to an inner conductor 630 of a coaxial cable 629. One end of line conductor 605 is electrically connected to an inner conductor 633 of a coaxial cable 632. The other end of line conductor 605 is electrically connected to an inner conductor 636 of a coaxial cable 635. One end of line conductor 607 is electrically connected to inner conductor 627. The other end of line conductor 607 is electrically connected to inner conductor 630. One end of line conductor 608 is electrically connected to inner conductor 633. The other end of line conductor 608 is electrically connected to inner conductor 636.

Chip resistors 614 and 615 are inserted in line conductor 604 such that line conductor 604 is divided into three segments. Chip resistors 616 and 617 are inserted in line conductor 605 such that line conductor 605 is divided into three segments. One end of chip resistor 618 is electrically connected to line conductor 604 between chip resistor 614 and chip resistor 615, and the other end is electrically connected to grounded conductor 606. One end of chip resistor 619 is electrically connected to line conductor 605 between chip resistor 616 and chip resistor 617, and the other end is electrically connected to line conductor 606. Chip resistors 620 and 621 are inserted in line conductor 607 such that line conductor 607 is divided into three segments. Chip resistors 622 and 623 are inserted in line conductor 608 such that line conductor 608 is divided into three segments. One end of chip resistor 624 is electrically connected to line conductor 607 between chip resistor 620 and chip resistor 621, while the other end is electrically connected to grounded conductor 609. Chip resistor 625 is electrically connected to line conductor 608 between chip resistor 622 and chip resistor 623, while the other end is electrically connected to line conductor 609. Chip resistors 614 and 620 are identical or equivalent. Chip resistor 615 and chip resistor 621 are identical or equivalent. Chip resistor 616 and chip resistor 622 are identical or equivalent. Chip resistor 617 and chip resistor 623 are identical or equivalent. Chip resistor 618 and chip resistor 624 are identical or equivalent. Chip resistor 619 and chip resistor 625 are identical or equivalent. Shield case 602 is electrically connected to an outer conductor 628 of coaxial cable 626, an outer conductor 631 of coaxial cable 629, an outer conductor 634 of coaxial cable 632, an outer conductor 637 of coaxial cable 635, grounded conductor 610, grounded conductor 611, grounded conductor 612, and grounded conductor 613.

Coaxial cables 626 and 632 are connected to a signal source 638. Line conductors 604 and 607 are driven under the same phase by signal source 638 via coaxial cable 626. Line conductors 605 and 608 are driven under the same phase by signal source 638 via coaxial cable 632. It should be noted that line conductor 605 is driven under the phase opposite that of line conductor 604.

The distance between line conductor 604 and grounded conductor 610 everywhere on line conductor 604 is narrower than half the distance between line conductor 604 and line conductor 605. Thus, the characteristic impedance of the coplanar line containing line conductor 604 is determined or controlled by the distance between line conductor 604 and grounded conductor 610. The distance between line conductor 605 and grounded conductor 611 everywhere on line conductor 605 is narrower than half the distance between line conductor 604 and line conductor 605. Thus, the characteristic impedance of the coplanar line containing line conductor 605 is determined or controlled by the distance between line conductor 605 and grounded conductor 611. The distance between line conductor 607 and grounded conductor 612 everywhere on line conductor 607 is narrower than half the distance between line conductor 607 and line conductor 608. Thus, the characteristic impedance of the coplanar line containing line conductor 607 is determined or controlled by the distance between line conductor 607 and grounded conductor 612. The distance between line conductor 608 and grounded conductor 613 everywhere on line conductor 608 is narrower than half the distance between line conductor 607 and line conductor 608. Thus, the characteristic impedance of the coplanar line containing line conductor 608 is determined or controlled by the distance between line conductor 608 and grounded conductor 613.

The circuit formed on the front surface of PCB 601 and the circuit formed on the back surface of PCB 601 are plane symmetric with respect to PCB 601. Consequently, the conductors formed on the front surface of PCB 601 and the corresponding conductors formed on the back surface of PCB 601 are plane symmetric with respect to PCB 601. Moreover, the position of the chip resistors mounted on the front surface of PCB 601 and the position of the corresponding chip resistors mounted on the back surface of PCB 601 are plane symmetric with respect to PCB 601. For instance, line conductor 604 and line conductor 607 are plane symmetric with respect to PCB 601. The position of resistor 614 and the position of resistor 620 are plane symmetric with respect to PCB 601. The position of resistor 618 and the position of resistor 624 are plane symmetric with respect to PCB 601.

It should be noted that it is preferred that the distance between line conductor 604 and grounded conductor 610 be 1/10 or less the distance between line conductor 604 and line conductor 605. In this case, the sensitivity of the distance between line conductor 604 and line conductor 605 to the characteristic impedance of the coplanar line containing line conductor 604 becomes 1/10 or less the sensitivity of the distance between line conductor 604 and grounded conductor 610 to the characteristic impedance. As a result, line conductor 605 can be practically disregarded with respect to the characteristic impedance of the coplanar line containing line conductor 604. It is preferred that the distance between line conductor 605 and grounded conductor 611 be 1/10 or less the distance between line conductor 604 and line conductor 605. In this case, the sensitivity of the distance between line conductor 604 and line conductor 605 to the characteristic impedance of the coplanar line containing line conductor 604 becomes 1/10 or less the sensitivity of the distance between line conductor 605 and grounded conductor 611 to the same characteristic impedance. As a result, line conductor 604 can be practically disregarded with respect to the characteristic impedance of the coplanar line containing line conductor 605. It is preferred that the distance between line conductor 607 and grounded conductor 612 be 1/10 or less the distance between line conductor 607 and line conductor 608. In this case, the sensitivity of the distance between line conductor 607 and line conductor 608 to the characteristic impedance of the coplanar line containing line conductor 607 becomes 1/10 or less the sensitivity of the distance between line conductor 607 and grounded conductor 612 to the same characteristic impedance. As a result, line conductor 608 can be practically disregarded with respect to characteristic impedance of the coplanar line containing line conductor 607. It is preferred that the distance between line conductor 608 and grounded conductor 613 be 1/10 or less the distance between line conductor 607 and line conductor 608. In this case, the sensitivity of the distance between line conductor 607 and line conductor 608 to the characteristic impedance of the coplanar line containing line conductor 608 becomes 1/10 or less the sensitivity of the distance between line conductor 608 and grounded conductor 613 to the same characteristic impedance. As a result, line conductor 607 can be practically disregarded with respect to the characteristic impedance of the coplanar line containing line conductor 608.

The attenuators and power dividers in each of the above-mentioned embodiments can be produced using a multilayered substrate. In this case, the each PCB of the attenuators and the dividers has multiple layers wherein one layer having a circuit shown by FIGS. 3a, 5a, 6a, 7a, and 8a is the top layer and the other layers having the circuit shown by FIGS. 3b, 5b, 6b, 7b, and 8b are underneath the top layer. For instance, when PCB 201 shown in FIGS. 3a and 3b is multilayered, the multilayered PCB has multiple layers wherein a layer having the circuit shown in FIG. 3a is the top layer and the other layers having the circuit shown by FIG. 3b are underneath the top layer.

Moreover, in each of the above-mentioned embodiments, it is possible to change the one part mounted on the PCB to multiple parts and to change the multiple parts mounted on the PCB to one part. It should be noted that the position of these parts must be plane symmetric with respect to the PCB when the circuit formed on the PCB operates as a distributed constant circuit. Although this plane symmetry is preferred when the circuit formed on the same PCB operates as an lumped constant circuit, it is not necessary.

Furthermore, in each of the above-mentioned embodiments, the circuits formed on either side of the PCB and connected in parallel can be electrically connected by means such as conductor patterns formed on the PCB or vias that pass through the PCB, in place of or in addition to the parallel connection via the coaxial cables and shield case.

The following reference numbers are included in the in the drawings:
100 Attenuator
101 Printed circuit board
102 Shield case
103 Substrate
104, 105 Line conductors
106 Grounded conductor
107, 108, 109 Chip resistors
110 Via
111, 114 Coaxial cables
112, 115 Inner conductors
113, 116 Outer conductors
200 Attenuator
201 Printed circuit board
202 Shield case
203 Substrate
204, 205, 206, 207 Line conductors
208, 209, 210, 211 Grounded conductors
220, 223 Coaxial cables
221, 224 Inner conductors
222, 225 Outer conductors
212, 213, 214, 215 Chip resistors
217, 218, 219 Chip resistors
226 Signal source
300 Divider
302 Shield case
303 Substrate
304 Line conductor
305, 306, 307, 308 Line conductors
309, 310 Grounded conductors
312, 313, 314, 316, 317, 318 Chip resistors
320, 323, 326 Coaxial cables
321, 324, 327 Inner conductors
322, 325, 328 Outer conductors
329 Signal source
400 Divider
404, 406 Line conductors
414 Chip resistor
500 Attenuator
502 Shield case
503 Substrate
504, 505, 506, 507 Line conductors
508, 509, 510, 511 Grounded conductors
512, 513, 514, 515, 516, 517 Chip resistors
518, 519, 520, 521, 522, 523 Chip resistors
524, 527, 530, 533 Coaxial cables
525, 528, 531, 534 Inner conductors
526, 529, 532, 535 Outer conductors
536 Signal course
600 Attenuator
602 Shield case
603 Substrate
604, 605, 606, 607, 608, 609 Line conductors
610, 611, 612, 613 Grounded conductors
614, 615, 616, 617, 618, 619 Chip resistors
620, 621, 622, 623, 624, 625 Chip resistors
626, 629, 632, 635 Coaxial cables
627, 630, 633, 636 Inner conductors
628, 631, 634, 637 Outer conductors
638 Signal source

1. A circuit comprising:
a first coplanar line including a first strip conductor formed on the first plane of a dielectric substrate and a first grounded conductor formed on the first plane and disposed on one side of the first strip conductor; and
a second coplanar line including a second strip conductor formed on a second plane of the dielectric substrate and a second grounded conductor formed on the second plane and disposed on one side of the second strip conductor,
wherein the first strip conductor and the second strip conductor are electrically connected in parallel and are plane symmetric with respect to the dielectric substrate, and
the first grounded conductor and the second grounded conductor are electrically connected in parallel and are plane symmetric with respect to the dielectric substrate.

2. The circuit according to claim 1, wherein at least a portion of the first coplanar line and at least a portion of the second coplanar line are covered or enclosed by a shielding member.

3. The circuit according to claim 1, further comprising at least one first electronic part inserted in the first strip conductor and at least one second electronic part, which is the identical or equivalent electronic part as the first electronic part and is inserted in the second strip conductor.

4. The circuit according to claim 3, wherein the position of the second electronic part and the position of the first electronic part are plane symmetric with respect to the dielectric substrate.

5. The circuit according to claim 1, further comprising at least one first electronic part having at least one end electrically connected to the first strip conductor and disposed on the other side of the first strip conductor.

6. The circuit according to claim 5, further comprising at least one second electronic part, which is the identical or equivalent electronic part as the first electronic part, has at least one end electrically connected to the second strip conductor, and is disposed on the other side of the second strip conductor.

7. The circuit according to claim 6, wherein the position of the second electronic part and the position of the first electronic part are plane symmetric with respect to the dielectric substrate.

8. The circuit according to claim 1, further comprising:
a third grounded conductor formed on the first plane and disposed on the other side of the first strip conductor, wherein the distance between the third grounded conductor and the first strip conductor is wider than the distance between the first grounded conductor and the first strip conductor; and
a first electronic part, which has one end connected to the third grounded conductor and is disposed between the third grounded conductor and the first strip conductor.

9. The circuit according to claim 8, wherein the distance between the third grounded conductor and the first strip conductor is greater by five times or more than the distance between the first grounded conductor and the first strip conductor.

10. The circuit according to claim 8, further comprising:
a fourth grounded conductor formed on the second plane and disposed on the other side of the second strip conductor, wherein the distance between the fourth grounded conductor and the second strip conductor is wider than the distance between the second grounded conductor and the second strip conductor; and
a second electronic part, which is the identical or equivalent electronic part as the first electronic part, has one end connected to the fourth grounded conductor, and is disposed between the fourth grounded conductor and the second strip conductor.

11. The circuit according to claim 10, wherein the distance between the fourth grounded conductor and the second strip conductor is greater by five times or more than the distance between the second grounded conductor and the second strip conductor.

12. The circuit according to claim 1, wherein the dielectric substrate is a resin substrate.

13. A circuit comprising:
a first coplanar line including a first strip conductor formed on a first plane of a dielectric substrate and a second strip conductor formed on the first plane and disposed on one side of the first strip conductor; and
a second coplanar line including a third strip conductor and a fourth strip conductor formed on a second plane of the dielectric substrate,
wherein the first strip conductor and the third strip conductor are electrically connected in parallel and are plane symmetric with respect to the dielectric substrate, and
the second strip conductor and the fourth strip conductor are electrically connected in parallel and are plane symmetric with respect to the dielectric substrate.

14. The circuit according to claim 13, wherein at least a portion of the first coplanar line and at least a portion of the second coplanar line are covered or enclosed by a shielding member.

15. The circuit according to claim 13, wherein:
the first strip conductor and the second strip conductor are disposed between the first grounded conductor formed on the first plane and the second grounded conductor formed on the first plane,
the third strip conductor and the fourth strip conductor are disposed between the third grounded conductor formed on the second plane and the fourth grounded conductor formed on the second plane,
the distance between the first strip conductor and the first grounded conductor and the distance between the second strip conductor and the second grounded conductor are less than half the distance between the first strip conductor and the second strip conductor; and
the distance between the third strip conductor and the third grounded conductor and the distance between the fourth strip conductor and the fourth grounded conductor are less than half the distance between the third strip conductor and the fourth strip conductor.

16. The circuit according to claim 15, wherein:
the distance between the first strip conductor and the first grounded conductor and the distance between the second strip conductor and the second grounded conductor are 1/10 or less the distance between the first strip conductor and the second strip conductor, and
the distance between the third strip conductor and the third grounded conductor and the distance between the fourth strip conductor and the fourth grounded conductor are 1/10 or less the distance between the third strip conductor and the fourth strip conductor.

17. The circuit according to claim 13, wherein:
the first strip conductor and the second strip conductor are disposed between the first grounded conductor formed on the first plane and the second grounded conductor formed on the first plane,
the third strip conductor and the fourth strip conductor are disposed between the third grounded conductor formed on the second plane and the fourth grounded conductor formed on the second plane,
the distance between the first strip conductor and the first grounded conductor and the distance between the second strip conductor and the second grounded conductor are greater than half the distance between the first strip conductor and the second strip conductor, and
the distance between the third strip conductor and the third grounded conductor and the distance between the fourth strip conductor and the fourth grounded conductor are greater than half the distance between the third strip conductor and the fourth strip conductor.

18. The circuit according to claim 17, wherein:
the distance between the first strip conductor and the first grounded conductor and the distance between the second strip conductor and the second grounded conductor are greater by 2.5 times or more than the distance between the first strip conductor and the second strip conductor, and
the distance between the third strip conductor and the third grounded conductor and the distance between the fourth strip conductor and the fourth grounded conductor are greater by 2.5 times or more than the distance between the third strip conductor and the fourth strip conductor.

19. The circuit according to claim 13, wherein the dielectric substrate is a resin substrate.
